(19) United States
(12) Patent Application Publication
(10) Pub. No.: US 2003/0027026 A1
(43) Pub. Date: Feb. 6, 2003

(54) Fuel cell installation for use as a drive unit for a vehicle and operating method

(76) Inventors: Rolf Bruck, Bergisch Gladbach (DE); Joachim Grosse, Erlangen (DE); Jorg-Roman Konieczny, Siegburg (DE); Arno Mattejat, Bubenreuth (DE); Meike Reizig, Bonn (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/178,643

(22) Filed: Jun. 24, 2002

Related U.S. Application Data
(63) Continuation of application No. PCT/DE00/04596, filed on Dec. 22, 2000.

(30) Foreign Application Priority Data
Dec. 23, 1999 (DE) 199 62 684.7

(51) Int. Cl. H01M 8/04

(52) U.S. Cl. 429/24; 429/13

(57) ABSTRACT

The fuel cell installation is monitored and controlled with regard to its system dynamics during its use as the prime mover energy supply of a vehicle. The system is configured to provide half its maximum output after less than 5 minutes following a stationary phase of up to 3 weeks.

### Cross-Reference to Related Application

This application is a continuation of copending International Application No. PCT/DE00/04596, filed Dec. 22, 2000, which designated the United States and which was not published in English.

### BACKGROUND OF THE INVENTION

### FIELD OF THE INVENTION

The invention relates to a fuel cell installation as a drive unit for a vehicle, in which, for fuel cell operation, there are means for monitoring and setting a predetermined operating temperature, and in which the operating temperature is set during starting after stationary periods. In this context, the system dynamics relate in particular to a fuel cell installation of this type during starting from the cold state, in particular after relatively long stationary periods, which system provides the energy for a drive unit of a vehicle.

The use of PEM technology for driving vehicles is known from Keith B. Prater: “Solid polymer fuel cell developments at Ballard” in Journal of Power Sources, 37 (1992) 181-188, which describes a bus with system dynamics which for starting uses other energy sources, such as batteries, and after starting has only a moderate acceleration of 20 s from 0 to 50 kmh (˜31 mph).

The monitoring of the temperature of fuel cell installations and the setting of predetermined desired temperatures for optimum operation is well known from the prior art. In this context, reference is had, by way of example, to the Japanese disclosures JP 08-033119 A, JP 09-231991 A, JP 07-094202, JP 09-312165 A, JP 59-073858 A, JP 62-131478 A and JP 61-158672 A (specific reference is had to the corresponding abstracts). Furthermore, international PCT publication WO 96/41393 A discloses a fuel cell installation with a temperature control system. Furthermore, German published patent application DE 198 25 286 A relates to cooling-water circulation and British reference GB-A 1 304 092 describes a control system for all operating parameters.

Finally, the prior art has also disclosed with some detail temperature-insulation means, known as Dewar vessels in which it is possible to dispose a fuel cell installation.

### SUMMARY OF THE INVENTION

It is accordingly an object of the invention to provide a fuel cell installation for use as a drive unit for a motor vehicle, which overcomes the above-mentioned disadvantages of the heretofore-known devices and methods of this general type and which provides for attractive system dynamics and/or user-friendly service intervals.

With the foregoing and other objects in view there is provided, in accordance with the invention, a fuel cell installation for driving a vehicle, comprising:

a monitoring device for operating a fuel cell unit and setting a predetermined operating temperature, and for setting the operating temperature during starting of the fuel cell unit after a stationary period;

the monitoring device including an input for receiving a signal from a temperature sensor for measuring an ambient temperature;

the monitoring device taking into account an ambient temperature curve during the stationary period and a component temperature, and the monitoring device including a timer for accurately switching in individual auxiliary units to ensure at least one of the following: after a stationary period of up to 25 h, half a maximum output is reached in less than one minute and, after a stationary period of up to 3 weeks, half the maximum output is reached after at most 5 minutes.

In accordance with an added feature of the invention, at least three switching stages are provided for starting and for accurately switching in the individual auxiliary units.

In accordance with an additional feature of the invention, the fuel cell unit is provided with sufficient insulation to assure that the desired output level is reached within the predetermined time. Preferably, the insulation is a vacuum insulation.

In accordance with another feature of the invention, the auxiliary units include a phase change material, i.e., a latent heat store, and/or a direct or indirect heating device. The system may further be provided with a device for starting a burner.

In accordance with a further feature of the invention, the fuel cell unit is configured such that in a hot operating state 90% of the maximum output is available within only 5 seconds after startup.

With the above and other objects in view there is also provided, in accordance with the invention, a method of operating a fuel cell installation for driving a vehicle, which comprises:

monitoring the fuel cell installation with regard to an operating temperature thereof and setting the operating temperature during starting of the fuel cell unit after a stationary period;

measuring an ambient temperature during the stationary period and a component temperature;

taking into account the ambient temperature curve during the stationary period and the component temperature for starting the fuel cell installation after the stationary period, and switching in individual auxiliary units under timer control to ensure at least one of the following:

half a maximum output is reached in less than one minute upon starting after a stationary period of up to 25 h; and

half the maximum output is reached after at most 5 minutes upon starting after a stationary period of up to three weeks.

In other words, the invention relates to a fuel cell installation as a drive unit for a vehicle with which it is ensured that, after a preceding stationary phase of 8 to 24 h, half its maximum output is generated in less than one minute, and/or after a preceding stationary phase of up to 3 weeks, half its maximum output is produced after at most 5 min. In this system, a significant difference compared to the prior art is that not only is the working temperature constantly controlled while the fuel cell installation is operating, but rather, in particular during stationary periods, i.e. when the vehicle which is driven by the fuel cell installation is not operating, the temperature profile of the environment and of the system is taken into account for its further operation.

The installation preferably operates with polymer electrolyte fuel cells (PEM) fuel cells, particularly preferably with HT-PEM fuel cells, which are a high-temperature variant of the known PEM fuel cells.

It is preferable for the system to provide over half its maximum output even more quickly, i.e. it is preferable that, after a stationary period of up to 24 h, half the maximum output is available after approx. 40 s, and in particular after approximately 20 s.

After a stationary phase of 3 weeks, half the maximum output is preferably available after approx. 4 min, and particularly preferably after approx. 3 min.

In this context, the time indications merely represent the order of magnitude of the system dynamics, and relatively minor fluctuations, such as for example 48% of the maximum power in one minute and two seconds, still lie within the scope of the invention, since the order of magnitude of the dynamics remains identical.

The running fuel cell installation which is ready for operation runs up to approx. 90% of output in a time period of approx. 5 s, preferably approx. 3 s and particularly preferably approx. 2 s.

The fuel cell installation preferably has a service life which corresponds to a motor vehicle traveling distance of up to 250,000 km (˜155,000 miles).

Other features which are considered as characteristic for the invention are set forth in the appended claims.

Although the invention is illustrated and described herein as embodied in a fuel cell installation for use as a drive unit for a vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic view of a motor vehicle with an electric motor that is supplied energy from a fuel cell installation;

FIGS. 2A and 2B are two partial figures illustrating diagrams explaining the properties of the fuel cell installation shown in FIG. 1; and

FIG. 3 is a schematic block diagram showing technical means of implementing the starting characteristics of a fuel cell installation for supplying energy in a motor vehicle in the sense of FIG. 2.

### DESCRIPTION OF THE PREFERRED EMBODIMENTS

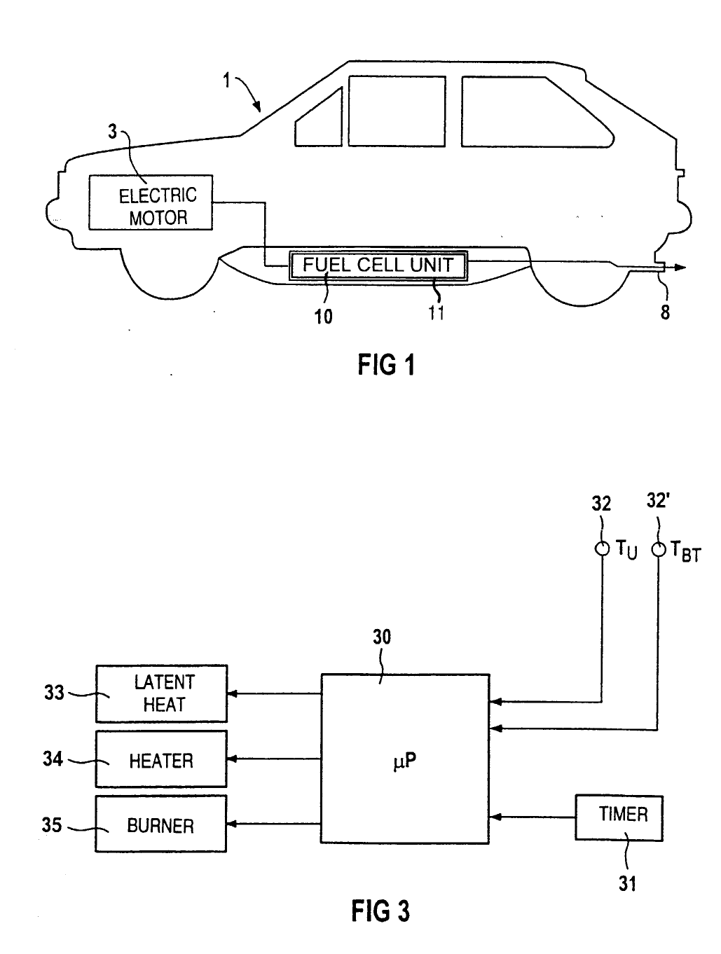

Referring now to the figures of the drawing in detail and first, particularly, to FIG. 1 thereof, there is shown a motor vehicle 1 which, by way of example, has an electric motor 3 as its drive and a fuel cell unit 10 for supplying the drive. The fuel cell unit may advantageously be a so-called PEM (proton exchange membrane, polymer electrolyte membrane) fuel cell, in particular including an HT fuel cell which operates at temperatures which are higher than normal, in the range from 100 to 300° C. The PEM fuel cell is operated using hydrogen or hydrogen-rich gas which is obtained by reforming from alcohols, such as for example methanol, or alternatively from gasoline, and oxygen, in particular atmospheric oxygen from the environment as oxidizing agent.

The fuel cell unit 10 is encased in sufficient insulation 11 to assure that the necessary operating temperature for efficient power output is reached as quickly as possible. Preferably, the insulation 11 is a vacuum insulation. In a specific implementation, the insulation 11 is a Dewar vessel.

For the sake of completeness, the drawing includes an exhaust 8, in which, during operation with pure hydrogen, product water can escape or, during operation with hydrogen-rich gas, exhaust gases which are present can also escape.

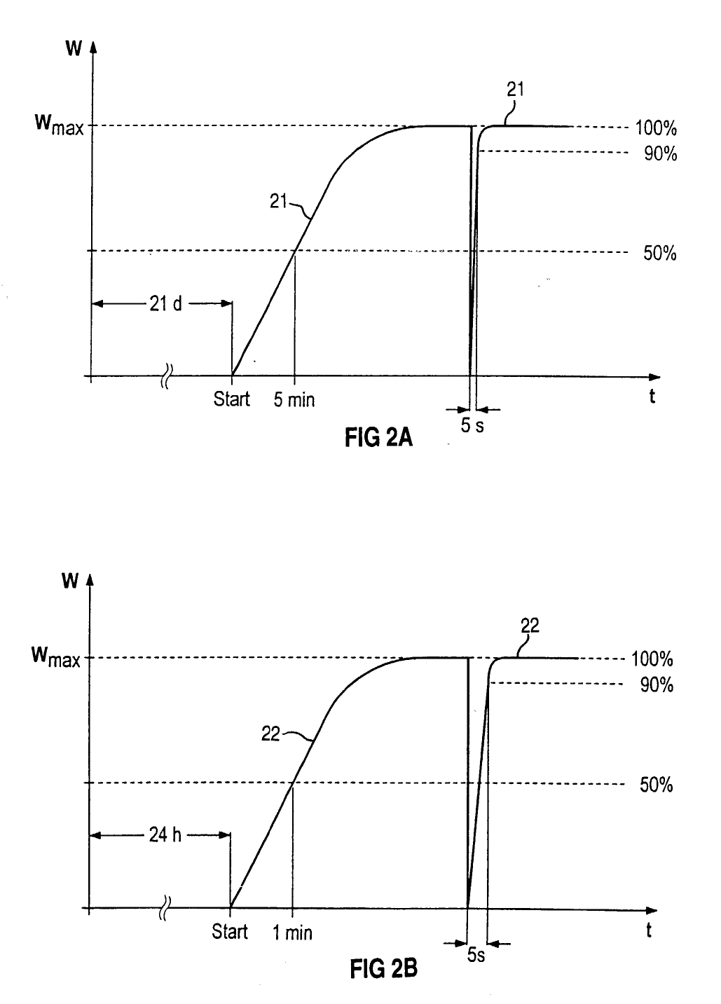

The graphs illustrated in FIG. 2 each plot the time on the abscissa and the power which is achieved on the ordinate. The line of 100% output is in each case a predetermined parallel to the abscissa.

In FIG. 2A, a characteristic curve is denoted by 21, and in FIG. 2B a characteristic curve is denoted by 22. The characteristic curves characterize the invention. The characteristic curve 21 shows a starting curve for a fuel cell installation 10 as shown in FIG. 1 which has not been operated for a relatively long period of time, for example two or three weeks. It can be seen from the characteristic curve 21 that, in the event of interruptions of up to three weeks (21 days), half the maximum output Wₘₐₓ is already available just five minutes after the fuel cell installation has been started. The maximum output Wₘₐₓ is reached with the same increase in time.

If, after prolonged operation or start-stop operation, the fuel cell installation has been switched off, for example overnight, i.e. for example ten or twelve hours, and is then started again, the maximum output Wₘₐₓ is reached within a significantly shorter time, namely as little as one minute. This applies for stationary periods of up to one day, i.e. 24 hours.

FIG. 2B shows, by way of example, using a correspondingly larger scale on the abscissa, start-stop operation of a fuel cell installation 10 in a motor vehicle 1, as occurs in daily practical use. The characteristic curve 22 reaches half the maximum output within as little as one minute (1 min).

If the motor vehicle 1 that is equipped with the fuel cell installation 10 is switched off from power operation and is then once more started while it is still in its hot operating state, it reaches approximately 90% of its maximum output Wₘₐₓ after just 5 seconds. This is illustrated in FIGS. 2A and 2B in each case in the right-hand portion of the curves 21 and 22.

A significant aspect of the invention is that, in practical operation of a motor vehicle, the required output is available within a reasonable time after starting. The ambient temperature during the stationary phases should not have any crucial influence on the power output after starting. It must also be ensured that a sufficiently long operating life of the fuel cell installation is achieved. The operating life, which is normally calculated in hours, has to be matched to the driving capacity of the vehicle, in such a way that a service life of the fuel cell installation corresponds to approximately 250,000 driving kilometers (˜150,000 miles) of the vehicle.

To achieve a rapid warming up of the fuel cell installation during starting, in particular after a cold start and a relatively long stationary period, the fuel cell installation may advantageously be assigned starting means, in particular for rapid starting. Such means are first of all sufficient insulation of the fuel cells with respect to the environment, which ensures that they remain ready for operation even over periods of hours. Phase change materials and means for direct or indirect heating of at least the fuel cell stack can be connected as additional measures for longer stationary periods and low ambient temperatures. A heating device of this type may be a burner that can be operated from the vehicle on-board battery.

To implement the measures described, in FIG. 3 a processor 30, for example a microprocessor up which is already present for engine management, is advantageously programmed in such a way that, under control of a timer 31, it automatically executes defined switching measures at defined times. The ambient temperature Tᵤ which is recorded by a sensor 32 and also the component temperature T_{BT} (i.e., the temperature of the fuel cell stack, the fuel cell unit, and/or the fuel cell auxiliary units) for which if appropriate a plurality of sensors are present, are taken into account. In the processor 30, the recorded values are processed using predetermined programs, so that suitable measures to achieve the desired operational readiness are determined.

To ensure comprehensive availability of the fuel cell installation 10 with the above details, the measures described are initiated and, if necessary, by way of example a latent heat store 33, referred to herein as a phase change material 33 is switched on or a heating device 34 is activated. In addition to a heating device of this type, there may be provided a burner 35 for additional heating.

When the motor is being started, first of all the cooling installation can be short-circuited, in order to make the waste heat which is generated by the motor directly useable for heating the fuel cell installation. Especially with means of this type, it is possible for fuel cells to be heated up to the required operating temperature within minutes. There is generally no need for any further measures to allow the fuel cell installation to reach its hot operating state. In the event of a load change and/or a restart, >90% of the maximum output is reached and available within approximately 5 minutes.

Particularly when HT-PEM fuel cells are being used, which operate at a higher temperature than the standard temperature of PEM fuel cells, namely up to 300° C., these may be means for direct or indirect heating of the fuel cell installation. This is important whenever the HT fuel cell installation contains phosphoric acid in the electrolyte which, depending on the concentration, may solidify at temperatures of 40° C. and therefore has to be liquefied first of all. The liquefaction can be effected by the above-mentioned heating or by diluting, with a resultant reduction in the melting point of the phosphoric acid.

Other means are also possible which influence the starting performance of a PEM fuel cell installation, in particular HT fuel cells which have operating temperatures in the range between 80 and 300° C.

We claim:

1. A fuel cell installation for driving a vehicle, comprising:
a monitoring device for operating a fuel cell unit and setting a predetermined operating temperature, and for setting the operating temperature during starting of the fuel cell unit after a stationary period;
said monitoring device including an input for receiving a signal from a temperature sensor for measuring an ambient temperature;
said monitoring device taking into account an ambient temperature curve during the stationary period and a component temperature, and said monitoring device including a timer for accurately switching in individual auxiliary units to ensure at least one of the following: after a stationary period of up to 25 h, half a maximum output is reached in less than one minute and, after a stationary period of up to 3 weeks, half the maximum output is reached after at most 5 minutes.

2. The fuel cell installation according to claim 1, wherein at least three switching stages are provided for starting and for accurately switching in the individual auxiliary units.

3. The fuel cell installation according to claim 1, wherein said fuel cell unit is provided with sufficient insulation to assure that a necessary output level is reached within a predetermined time.

4. The fuel cell installation according to claim 3, wherein said insulation is a vacuum insulation.

5. The fuel cell installation according to claim 1, wherein said auxiliary units include a phase change material.

6. The fuel cell installation according to claim 1, wherein said auxiliary units include a direct heating device.

7. The fuel cell installation according to claim 1, wherein said auxiliary units include an indirect heating device.

8. The fuel cell installation according to claim 1, which comprises a device for starting a burner.

9. The fuel cell installation according to claim 1, wherein said fuel cell unit is configured such that in a hot operating state 90% of the maximum output is available within only 5 seconds after startup.

10. The fuel cell installation according to claim 1, which comprises a high-temperature polymer electrolyte membrane fuel cell having an ion-conducting electrolyte.

11. The fuel cell installation according to claim 1 configured for a service life corresponding to up to 250,000 km (˜150,000 miles) of the motor vehicle.

12. The fuel cell installation according to claim 11, which comprises an HT-PEM fuel cell stack.

13. A method of operating a fuel cell installation for driving a vehicle, which comprises:
monitoring the fuel cell installation with regard to an operating temperature thereof and setting the operating temperature during starting of the fuel cell unit after a stationary period;
measuring an ambient temperature during the stationary period and a component temperature;
taking into account the ambient temperature curve during the stationary period and the component temperature for starting the fuel cell installation after the stationary period, and switching in individual auxiliary units under timer control to ensure at least one of the following:
half a maximum output is reached in less than one minute upon starting after a stationary period of up to 25 h; and
half the maximum output is reached after at most 5 minutes upon starting after a stationary period of up to three weeks.

14. The method according to claim 13, which comprises selectively switching in at least three switching stages in switching in the individual auxiliary units.
